(19) United States
(12) Patent Application Publication
(10) Pub. No.: US 2026/0167373 A1
(43) Pub. Date: Jun. 18, 2026

(54) METHOD AND MEASURING ASSEMBLY FOR QUALITY CONTROL OF PACKAGING UNITS

(71) Applicant: Krones Aktiengesellschaft, Neutraubling (DE)

(72) Inventors: Florian SAUMWEBER, Rosenheim (DE); Peter HAIDACHER, Kiefersfelden (DE); Marcus KREIS, Kolbermoor (DE)

(21) Appl. No.: 18/707,387

(22) PCT Filed: Oct. 25, 2022
(86) PCT No.: PCT/EP2022/079803

§ 371 Date: May 3, 2024

(30) Foreign Application Priority Data
Nov. 8, 2021 (DE) 10 2021 128 978.5

(51) Int. Cl. B65B 57/00; B65D 71/42; G01B 11/14

(52) U.S. Cl. CPC B65B 57/00; B65D 71/42; G01B 11/14

(57) ABSTRACT

The invention relates to a method and a measuring assembly for detecting deviations of a current status from a target status of a packaging unit (10), formed by at least two articles combined by strapping or a packaging blank (14), after production, by measuring the width of an intermediate space between two directly adjacent articles within the packaging unit (10) or by measuring a distance (B) between the shell surfaces of the adjacent articles in their most widely spaced-apart positions. A measured width of the intermediate space or a measured distance (B) represents a current status, which is compared with a defined or with a variably definable target status. The measuring assembly generates output signals (84) from the measured values and delivers them to a downstream evaluation unit (86), which is operatively connected to a packaging machine or is part of a packaging machine of this type.

### CLAIM OF PRIORITY

The present application claims priority to International Application PCT/EP2022/079803, filed Oct. 25, 2022, which in turn claims priority to German Application DE 10 2021 128 978.5, filed Nov. 8, 2021, which are incorporated by reference.

### FIELD OF THE INVENTION

The present invention relates to a method and a measuring assembly for quality control of packaging units, and to a packaging machine having such a measuring assembly with the features of the independent claims.

### BACKGROUND OF THE INVENTION

Metal beverage cans are one of the most important commercial packagings for beverages in addition to bottles and beverage cartons. Furthermore, they can also serve as a drinking vessel and thus form a packaging suitable for the end consumption. Such beverage cans made of thin rolled-out metal sheet are used primarily for carbonated beverages, such as can beer and soft drinks, such as cola beverages, sodas of all types and energy drinks. Beverage cans are typically opened for consumption by tear-off tabs arranged on the lid.

Beverage cans used in the present case usually consist of a single-piece, hollow-cylindrical container made of a suitable aluminum alloy or of tinplate and a folded or flanged lid made of the same material, in particular of aluminum, which are usually produced by a deep-drawing method. In the lid there is usually an oval scoring line and a riveted tab made of metal into which a finger of a human hand can engage, so that the tab can act as a prepared or integrated can opener, so to speak. The tab is designed in such a way that it presses the roughened oval into the interior of the can by lever effect when lifting and thus forms a pouring or drinking opening. The cans normally have a tapered diameter in the upper shell region below the lid. This means that the lid normally also has an outer diameter that is smaller than the cylindrical shell region of the can.

There are different types of packaging for processing, assembling, grouping and packaging articles such as beverage containers in the form of cans. A suitable variable of a type of packaging of this type is, for example, the grouping of articles or containers into portable, relatively handy bundle units, which can generally also be regarded as packaging units. In this regard, various options are known for combining individual cans into larger bundles. For example, beverage containers are often combined and packaged using shrink films to form bundles of four, six or more containers. The production of bundles is usually indispensable, because they are the most common variant of sales units or packaging units for beverage containers, in particular cans made of metal or plastic material or bottles made of PET plastics material. In some cases, the containers are combined again for transport and/or assembled and palletized in layers.

Specific fabrication steps are required in the production of known bundle types in order to be able to process the shrink films normally used for the bundles. Such fabrication steps require a relatively high energy input, not least because of the shrinking process of the film that takes place under the effect of heat. In addition, the film used incurs costs for production, provision, handling as well as later disposal, since it is no longer required after sale and the unpacking of the articles or containers. The machine configuration for providing the so-called film wrapping modules and other handling stations necessary for the film packaging also incurs high investment costs. Finally, a relatively high investment of capital is also needed for the provision of the so-called shrink tunnel, with which the film wrapped around the bundle is shrunk around the containers by hot air application.

A variant in which the use of shrink films can basically be dispensed with are so-called strapping bundles. In this case, the containers are connected to one another by so-called strapping bands and combined into a bundle. In continuous or cyclically operating strapping machines, containers, articles or bottles are grouped into formations and are then strapped with one or more bands using strapping assemblies. It is practical for such bands to run in the horizontal direction around the cylindrical shell surfaces of the containers or bottles and hold them together in the bundle composite. Typical formations can be, for example, 1×2 or 1×3 arrangements (two or three containers in a row), 2×2 arrangements (four containers in a square or diamond formation), 3×2, 4×3 or in principle also variable n×m arrangements.

Furthermore, the use of so-called upper gripping cardboard packages is known in order to combine a plurality of articles such as beverage containers, in particular bottles or cans, via their neck regions. A packaging machine for producing such bundles and for placing such upper gripping cardboard packages is described in patent specification EP 1 075 419 B1. There, the articles are arranged in a crate, and the gripping cardboard package is placed on top of the at least one article arranged in the crate. In particular, a plurality of articles is arranged in the crate, and by placing a smaller number of upper gripping cardboard packages on top, subgroups are formed, each of which combines some of the articles arranged in the crate.

Furthermore, packaging units are known which combine different types of secondary packaging device and the plurality of articles together with a first packaging device and a second packaging device, in particular with a first secondary packaging device in the form of an upper gripping cardboard package and with a second secondary packaging device in the form of a strapping and/or in the form of at least one adhesive connection.

If secondary packaging is mentioned at this juncture, there is a supplementation to the term primary packaging, which generally means the cans or bottles in which the actual material to be packaged, usually the beverage liquid, is located. The term secondary packaging can accordingly be used to refer to any film, strapping or gripping cardboard package, with the aid of which two or more such primary packagings can be held together mechanically and combined in one packaging unit. According to this system, packaging referred to optionally as tertiary packaging can be added, with which a plurality of packaging units can be combined and, for example, palletized.

Different variants of suitable packaging units and container packaging are known from the prior art, for example by DE 22 06 071 C2, by DE 25 31 325 A1 or by DE 10 2006 028 661 A1.

Further bundle variants are known from DE 20-2012-103 324 U1, from DE 1 457 489 A or from U.S. Pat. No. 5,775,486 A.

In principle, many different can sizes are widely available and commercially available. While cans having a capacity of 0.33 or 0.5 liters were conventionally offered, cans with 0.15, 0.25, 0.355 liters or other volumes are often also found.

Different can shapes are also known. While the lid of a standard can has a significantly smaller diameter than the can cylinder per se, the cylinder diameter and the lid diameter of so-called slim cans or sleek cans are substantially the same or nearly the same, such that there are no significant tapers in the lid and/or base region relative to the shell region of the can. It has been shown that such slim or sleek cans are more difficult to handle, since they provide some special features and difficulties when using gripping cardboard packages.

For combining standard cans, upper gripping cardboard packages that have a number of openings for the standard cans, which simultaneously define the positions of the cans within the packaging unit, are known. The gripping cardboard packages are pressed onto a set of standard cans from above, such that the lid region of the standard cans can pass through an assigned opening. Preferably, the gripping cardboard package is anchored below the lid region of the standard cans, in particular in the region of reduced cross section. The cans are arranged close together within the packaging unit produced in this way.

By contrast, the use of such gripping cardboard packages is usually not useful in the case of so-called slim cans or sleek cans. Since the diameter in the lid region and the diameter in the cylinder region are largely the same in this case, there is a lack of material between the openings of the gripping cardboard, such that the regions between the openings can easily tear out, as a result of which the gripping cardboard lacks the necessary stability. In order to address such limitations, multi-step packaging processes are proposed, for example, in WO 2021/043632 A1.

In view of the types of packaging and packaging methods known from the prior art and the known solutions for the different requirements of handling, which are in particular set by the container shapes of the primary packaging, in particular gripping cardboard packaging in which a container or can shell surface is included in the packaging process has proven to be practicable. In particular, this can be combined gripping cardboard and strapping packaging or pure gripping cardboard packages in which the container shell surfaces are partially enclosed, which causes the containers or cans to be held together as desired in the packaging unit.

In these combined types of packaging, all of which together have the gripping cardboard as secondary packaging that holds the primary packaging, it is desirable to be able to continuously monitor the packaging quality in the interest of a highest possible packaging quality and a desired freedom of error in the processing of the primary and secondary packagings. Known measuring methods for checking a band tension of strapping packagings can be used here, but these measurement methods are not suitable for any deviation of a detected current status from a desired target status of the packaging unit.

A measurement of a band tension by a spring balance necessarily requires a discontinuous process. In principle, random sample-like removals of individual packaging units from the product stream are possible, for example for carrying out other methods as a measurement by a spring balance, but such discontinuous measurements increase the monitoring effort in a way that is to be avoided if possible in the ongoing packaging process.

For the reasons mentioned, it can be considered as a primary objective of the invention to monitor the quality of the packaging units produced at any time and to detect deviations from a desired target status. This objective of the invention relates to both a production method for producing packaging units and to a packaging machine for processing and producing the packaging units, wherein the packaging machine can be equipped in particular with a suitable monitoring device or a suitable measuring assembly.

These objectives of the invention are achieved with the subjects of the independent claims. Features of advantageous further developments of the invention can be found in the dependent claims.

### SUMMARY OF THE INVENTION

For achieving at least some of the aforementioned objectives, the invention proposes a method used for quality control for detecting deviations of a current status from a target status of a packaging unit, formed by at least two articles combined by strapping and/or a packaging blank, after the production thereof, wherein this method according to the invention can be used in particular in conjunction with a production and/or packaging process and preferably in the region of a packaging machine.

In the method, a width of the intermediate space between two directly adjacent articles within the packaging unit and/or a distance between the shell surfaces of the adjacent articles in their most widely spaced-apart positions is measured. Current values, which can be compared with target values, can be derived from these determined values. A measured width of the intermediate space or a measured distance thus represents a current status of the packaging unit which can be compared with a defined or with a variably definable target status in order to reliably recognize faulty packaging units in this way.

With the aid of the method according to the invention, a faultless packaging unit can be detected if a deviation of the measured current status from a target status falls below a definable maximum value.

A target status that is characteristic of a corresponding packaging unit can be given, for example, by a defined minimum distance of the articles from one another in the packaging unit. Depending on the bundle variant produced or to be produced in each instance, such a minimum distance can be necessary; however, in other variants of packaging units, it can also assume the value zero. Thus, in the case of such packaging units in which a plurality of article rows is to be arranged in touching contact or in line contact, a desired target status can be given by a value of zero or approximately zero between adjacent articles in the packaging unit.

The target status to be sought can also be given by a parallel or approximately parallel positioning of the adjacent articles relative to one another in the packaging unit. In this case, the longitudinal central axes of the articles and/or their cylindrical shell surfaces are aligned exactly parallel to one another, which can be recognized or detected, for example, by simultaneously measuring the distances at two mutually spaced points of the article shell surfaces.

Depending on the method variant, the detection of the width of the intermediate space and/or the distance can take place optically, for example by a laser distance measurement or by a light barrier measurement or a combination of the measurement variants mentioned.

Likewise, the method can provide that the detection of the width of the intermediate space and/or the distance takes place optically by camera monitoring with downstream image evaluation of the camera signals, for example by evaluating gray shades or pixel images or the like, which are supplied by the camera.

Furthermore, method variants are also conceivable and useful in which the detection of the width of the intermediate space and/or the distance takes place in an acoustic manner, for example by an ultrasound measurement.

Finally, a further method variant can provide that the detection of the width of the intermediate space and/or the distance takes place by mechanically operating transducers, for example by start-up rollers, by contact brackets, the pivot angle of which is detected, or in another comparable or similar manner.

It is preferably to be provided in the method that largely all, in particular all processed packaging units without gaps are detected and measured, whereby inline detection during ongoing packaging operation is made possible, so that a reliable monitoring of all produced packaging units and the detection of all incorrectly produced packaging units is made possible.

The method can advantageously be used to use the collected measurement data for influencing and/or adjusting the packaging parameters during the production of the packaging units, whereby a real-time quality measurement with coupled quality control is created.

The packaging units produced and monitored can each be strapping bundles. Optionally, the produced and monitored packaging units can also each be bundles in which the articles are combined and held together by packaging blanks. In addition, the method can also be applied to such produced and monitored packaging units which are in each instance combined bundles in which the articles are combined by packaging blanks, wherein each of these packaging blanks is assigned a strapping section which surrounds article shell surfaces and holds the articles together in such a way.

In order to achieve at least some of the above-mentioned objectives, the invention furthermore proposes a measuring assembly which, in particular, can be an integrated component of a packaging machine for producing packaging units formed by at least two articles combined by strapping and/or a packaging blank. The packaging units produced by this packaging machine are thereby brought into the detection and measuring region of the measuring assembly and/or conveyed past the measuring assembly. The measuring assembly has suitable devices for measuring a width of the intermediate space between two directly adjacent articles within the packaging unit and/or for measuring a distance between the shell surfaces of the adjacent articles in their most widely spaced-apart positions.

In this case, it is provided that a measured width of the intermediate space or a measured distance represents a current status of the packaging unit, which can be compared with a defined or with a variably definable target status. In addition, it is provided that the measuring assembly generates output signals from the measured values and delivers them to a downstream evaluation unit which is operatively connected to the packaging machine, in particular in order to influence its control in the production of the packaging units in such a way that further deviations between the current status and the target status in the packaging units produced are reduced or preferably completely avoided.

The evaluation unit, which forms a component of the measuring assembly or is connected to it for signal exchange, can in particular form a component of a control device of the packaging machine. In this way, the collected measurement data can be used for influencing and/or adjusting the packaging parameters during the production of the packaging units, whereby a real-time quality measurement with coupled quality control is created.

The measuring devices of the can detect the width of the intermediate space and/or the distance between the shell surfaces of the adjacent articles in their most widely spaced-apart positions, for example optically, for example by a laser distance measurement or a light barrier measurement or also a combination of these measuring principles.

The measuring devices can optionally comprise at least one detection camera with downstream image evaluation of the camera signals, which makes it possible, for example, to evaluate gray shades or pixel images or the like.

Optionally, the measuring devices can detect the width of the intermediate space and/or the distance between the shell surfaces of the adjacent articles in their most widely spaced-apart positions by an ultrasound measurement.

It is also conceivable for the measuring devices to detect the width of the intermediate space and/or the distance between the shell surfaces of the adjacent articles in their most widely spaced-apart positions by mechanically operating transducers, for example by start-up rollers, by contact brackets, the pivot angle of which is detected, etc.

The measuring assembly according to the invention can preferably be used within a packaging machine with which packaging units are produced by a method according to one of the above-described embodiment variants.

If, from the point of view of a person skilled in the art, a meaningful combination with one another is possible, some of the or all of these above-mentioned variations or embodiment variants of the method according to the invention and/or of the measuring assembly according to the invention can optionally also be combined with one another in order to at least partially achieve the above-formulated objective(s), and/or to achieve the desired effect of the invention.

Finally, in order to achieve the above-mentioned objectives, a packaging machine for producing packaging units formed by at least two articles combined by strapping and/or a packaging blank is proposed, wherein this packaging machine is assigned a measuring assembly in the region of a transport section for the at least partially finished packaging units.

This measuring assembly has devices for measuring a width of the intermediate space between two directly adjacent articles within the packaging unit and/or for measuring a distance between the shell surfaces of the adjacent articles in their most widely spaced-apart positions, wherein a measured width of the intermediate space or a measured distance represents a current status of the packaging unit, which is compared with a defined or with a variably definable target status, and wherein the measuring assembly generates output signals from the measured values and delivers them to a downstream evaluation unit which is operatively connected to the packaging machine.

In one variant of the packaging machine, the evaluation unit downstream of the measuring assembly can be a component of a control device of the packaging machine, so that the collected measurement data can be used for influencing and/or adjusting the packaging parameters during the production of the packaging units, whereby a real-time quality measurement with coupled quality control is created.

It should be expressly mentioned at this point that all aspects and embodiment variants that have been explained in conjunction with the packaging machine according to the invention or the measuring assembly located therein can equally relate to, or form, partial aspects of the method according to the invention for producing the packaging units. Therefore, if the description or the claim definitions pertaining to the packaging machine and/or the measuring assembly according to the invention make mention of certain aspects and/or correlations and/or effects, this applies equally to the method according to the invention. The same applies vice versa, so that all aspects and embodiment variants which have been explained in conjunction with the method according to the invention can also relate to, or be, partial aspects of the packaging machine according to the invention and optionally also of the measuring assembly according to the invention. Therefore, if the description or the claim definitions pertaining to the method according to the invention make mention of certain aspects and/or correlations and/or effects, this applies equally to the packaging machine according to the invention and the measuring assembly according to the invention.

The following explanations again combine some aspects of the invention previously explained in different embodiment variants, clarify some aspects, but should not be considered in conflict with the statements already made, but in conjunction; in case of doubt, possibly as more specific variants and/or modifications. As already mentioned above multiple times, the measuring assembly according to the invention can thus serve to check the production quality of the packaging units produced. A current status to be compared with a target status have proven to be useful parameters for this purpose, wherein these can in particular be distance dimensions which can be detected in a suitable manner and can be tapped at the packaging units.

If packaging units are mentioned in the present context in conjunction with the above statements and/or the following description passages, the likewise customary term “bundle” can optionally also be used instead. The term “packaging unit” chosen here, and almost without exception, is intended to refer to the finished unit, which can be handled as a complete unit, possibly also stackable unit and/or unit that can be purchased and used by the end customer in retail stores, formed of at least two articles and the packaging device mechanically combining them. Optionally, it could also be mentioned that the packaging unit is a composite comprising at least two primary packagings which are mechanically combined by at least one secondary packaging and can thus be considered as a bundle composite or as a packaging unit.

The packaging units assembled and fabricated by the production method described below can comprise a total of six or eight similar articles, for example, which are held together in a rectangular arrangement by a flat packaging blank. Of course, the packaging units can optionally also comprise only four similar articles or possibly also ten or another reasonable number of articles which are held together in a rectangular arrangement by a flat packaging blank of suitable dimensions in each instance.

As has already been mentioned several times, in the production method of the packaging blank, the article grouping is initially placed and/or applied with a main surface covering the first or upper end faces or lid sides of the articles grouped, for example, in the 3×2 rectangular arrangement. With the placement and possibly already with the application of the packaging blank onto the upper side of the article grouping, i.e. onto the upper end faces of the grouped articles, connections between the articles and primary fixing device of the packaging blank are simultaneously formed. In addition, the primary fixing device to be explained in greater detail below define the positions of the articles relative to one another in that the dimensioning of the main surface of the packaging blank and the positions of the fixing device are coordinated with the dimensions of the articles and of the article grouping consisting of a plurality of articles.

After the packaging blank has been placed on the upper side of the article grouping, side surfaces are folded over to both longitudinal sides of the article grouping and placed against shell surfaces of the articles, but without following the curved contours of the shell surfaces.

As already explained, the articles can in particular each be similarly shaped cylindrical articles with largely uniformly shaped and continuously cylindrically contoured shell surfaces, for example, known beverage cans. The upper end faces and the bottom sides of the articles can be circular and optionally slightly concavely curved in. However, this generally does not mean a general limitation to such articles, so that they can optionally also have non-circular cross sections and consequently differently shaped shell surfaces with a non-cylindrical contour, for example polygonal cross sections with rounded edges or similar other shape variants. Such articles can in principle also be grouped in a comparable manner and combined into identical or very similar packaging units by such packaging blanks, as explained here on the basis of the cylindrically shaped articles.

The side surfaces in each instance form continuations of the main surface of the packaging blank and are located on both longitudinal sides of the main surface in a symmetrical arrangement. Together with strip sections, on both side surfaces, that continue to both narrow sides of the side surfaces, the two side surfaces adjacent to the main surface of the packaging blank are provided and designed to form secondary fixing device in each instance, which interact with them when applied to the shell surfaces of the articles.

By fixing overlapping end regions of the strip sections to one another and/or by fixing them to the shell surfaces of the articles, the secondary fixing device are formed by strapping sections. The strapping sections in each instance enclose defined regions of the shell surfaces of the articles, and specifically on both opposite narrow sides of the article grouping. The articles, which are fixed and held in position by the strapping sections, can only be swiveled or displaced minimally when the packaging unit is completed in this way, such that the secondary fixing device thus fix the articles within the packaging unit in a substantially parallel alignment of their longitudinal central axes to one another.

The strapping sections of the secondary fixing device are formed by the strip sections of the packaging blank, which extend the side surfaces to both narrow sides in directions along the longitudinal extension directions of the side surfaces.

The articles can be beverage cans, namely in particular so-called slim cans or sleek cans, which are manufactured from a suitable metal sheet, in particular from a suitable aluminum alloy, which can take place in particular by a deep-drawing method and a subsequent joining method for placing the lid. These beverage cans are hollow-cylindrical and closed on all sides. They also in each instance have a flat or slightly concavely curved-in circular base region on their lower end faces and a mostly flat circular upper lid region on the opposite end face. This upper lid region forms the aforementioned upper end face of the articles formed by the beverage cans.

The flat or slightly concave curved base region on the lower end face can typically be connected in one piece with the cylindrical shell surface, which can usually be achieved by a deep-drawing process in the case of tin cans. What in the present context is also referred to as the upper end face of the article is the upper lid region of the corresponding beverage can. The lid itself can, for example, be connected to the upper rim of the cylindrical shell of the beverage can by crimping, such that the can is closed on all sides. A tear-off lid or tear-off closure with a tear-off tab or the like may be incorporated into the lid, wherein scoring lines can be present as predetermined breaking points in the metal or aluminum sheet, which enable the tear-off closure to be opened to remove the liquid in the beverage can.

With such sleek cans or slim cans, the cylinder diameter in the region of the cylindrical shell surface and the outer circular diameters of the base region and of the lid region are typically substantially the same or nearly the same, wherein the base region and/or the lid region can be slightly indented or tapered relative to the cylindrical shell surface. Such a can shape with an almost uniformly cylindrical outer contour from the base to the lid is a characteristic feature of such so-called slim cans or sleek cans, whereas conventional (standard) cans normally have significantly smaller diameters in the base and lid regions than in their cylindrical shell regions. Therefore, when cans or beverage cans are referred to in the present context, this can in principle and in all cases mentioned mean such slim cans or sleek cans.

The gripping cardboard packages explained here or so-called upper gripping cardboard packages, which are known for combining standard cans and which have a number of openings for the standard cans to pass through, thus simultaneously define the positions of the cans within packaging units formed in this way. The gripping cardboard packages are normally pressed onto a set of standard cans from above, such that the lid region of the standard cans passes through an assigned opening. Often, the gripping cardboard package is anchored below the lid region of the standard cans, in particular in a region with a reduced cross section or in a constricted region just below the flanged edge, with which the lid is placed onto the upper edge region of the cylindrical shell region. Within a packaging unit produced thereby, the cans are arranged closely adjacently, normally with touching contact of their shell surfaces.

However, the use of such gripping cardboard packages in so-called slim cans or sleek cans is hardly sensible. Since, with such cans, there is little or no difference between the diameter in the lid region and the diameter in the cylindrical shell region, there is a lack of material between the openings of the gripping cardboard, such that the regions between the openings of adjacent cans can easily tear out, as a result of which the gripping cardboard lacks the necessary stability.

For this reason, the articles or beverage cans of the article grouping are spaced apart from one another initially, i.e. prior to the final shaping of the main surface of the packaging blank, along at least one of the main horizontal axes of the article grouping. A defined horizontal distance of the adjacent articles or beverage cans runs in a direction parallel to the second main axis of the article grouping.

This horizontal distance simultaneously represents a dimension of a target status of the finished packaging unit which, in the ideal state, should assume a value of zero as soon as the opposite strapping sections are placed around the shell surfaces of the articles or beverage cans located at the narrow sides of the article grouping and joined there to one another, preferably by applying a certain strapping band tension. Such a defined strapping band tension can reliably ensure that the individual articles or beverage cans are fixedly in line contact with one another in the composite of the packaging unit and do not develop any tendency to spread apart from one another in their lower base regions.

Instead of the horizontal distance dimension, a bundle width can optionally also be detected and regarded as a reasonable maximum for a target status to be aimed for. In order to detect this bundle width, a distance between the shell surfaces of the adjacent articles or beverage cans can be measured in their most widely spaced-apart positions, i.e. in a direction transverse to the first horizontal main axis and parallel to the second horizontal main axis.

However, it should be noted that the distance dimension mentioned here should only assume a value of zero or approximately zero with high reliability in certain variants of the packaging units held together with the upper packaging blank and the strapping sections arranged thereon, whereas in alternative bundle variants it is not absolutely useful to set this dimension to a target value of zero. In other bundle variants, such a value rather means an impermissible deviation that can supply an indication of a faulty bundle or a faulty packaging unit.

If, instead of the distance dimension, a defined bundle width is to be considered, this dimension in the bundle variants corresponds exactly to twice the article or can diameter with articles grouped in two rows and should only be minimally larger, since otherwise it is questionable whether the strapping sections are correctly arranged or connected and whether the required strapping band tension could be produced. On the other hand, an unusual measured value less than twice the article or can diameter would indicate deformed or pressed-in article or can shell surfaces, which would also be considered to be errors and could initiate a rejection process or could trigger another error message.

According to the system selected here, the two main axes of the article grouping run longitudinally and transversely to the grouped articles, wherein the first main axis lies parallel to the two rows, each with three or four articles or beverage cans aligned one behind the other or arranged one behind the other, while the second main axis orthogonal thereto runs transversely to these three rows or four rows (or possibly other number of articles).

Both main axes are normally oriented horizontally, since the article grouping is usually equipped and/or conveyed with the packaging blank in a defined direction of transport with the corresponding base regions of the beverage cans on suitable transport devices such as, for example, on horizontal conveyor devices. Therefore, the first main axis runs parallel or in the direction of the transport direction, such that the second main axis is oriented transversely to the transport direction.

In order to be able to ensure the desired reliable fixing of the articles or beverage cans within the packaging blank prepared for this purpose and in particular pre-punched, although, in the case of the slim or sleek cans explained here, which form the beverage cans, there is insufficient space for this between the upper lid regions of the adjacent beverage cans, it is necessary in the initial phase of equipping the article grouping, between the two rows of three or rows of four of beverage cans parallel to the first main axis, to produce the defined distance or a minimum dimension for a defined bundle width.

The mentioned arrangement with rows of beverage cans spaced apart by the horizontal distance (greater than zero) makes it possible to press a folding region of the packaging blank between the upper lid regions of the pairs of beverage cans initially spaced apart by the distance, as a result of which such beverage cans are simultaneously brought closer together in pairs until their shell surfaces are in line contact.

The folding region is located in the main surface of the packaging blank and divides it into two rectangular halves, which are located on either side of a vertical separating plane, which is located between the pairs of beverage cans spaced apart by the horizontal distance. The first main axis lies within such vertical separating plane, while the second main axis cuts perpendicularly through the vertical separating plane.

The folding region serves to form the primary fixing device by which the articles or beverage cans are held in the composite of the packaging unit as soon as the packaging blank is reshaped, pressed and folded in sections in the manner described here, and the secondary fixing device, which are formed here by the strapping sections, are brought into position and connected to one another in the intended manner.

After placing the packaging blank with its main surface onto the upper end faces of the articles or beverage cans brought into the article grouping in rectangular arrangement, which are, however, spaced apart from one another in pairs by the defined distance, the side surfaces of the packaging blank projecting laterally beyond the opposite longitudinal sides of the article grouping are folded down laterally so that they rest against the corresponding shell surfaces of the beverage cans. The side surfaces of the packaging blank are folded by approximately 90°. Optionally, the side surfaces can also be folded in two steps by less than 90° in each instance, so that a roof-shaped transition forms at a collar section, which, however, is to be understood only as a further optional variant of the machining and shaping method of the packaging blank. Further variants are conceivable, but are not explained in detail here.

In the present context, the extensions of the two side surfaces that project in the direction of both narrow sides of the main surface of the packaging blank clearly over the length of the main surface are also referred to as strip sections or as extended strip sections, since they have to fulfill a specific function in conjunction with the production and the formation of the secondary fixing elements. The strip sections are not normally attached subsequently to the side surfaces, but are an integral component of the side surfaces, wherein the strip sections as well as all other components and functional elements of the packaging blank may be produced from a cardboard sheet or similar flat packaging material in a single or possibly multi-stage punching process.

After the side surfaces have been folded over, wherein pre-folded and/or perforated or otherwise predetermined bent edges can be practically used on the longitudinal edges of the main surface of the packaging blank, the packaging blank is further processed in two phases in order to achieve the final state of the packaging unit. This two-phase further processing comprises pressing the main surface of the packaging blank over the entire length of the folding region running centrally through the main surface, which on the one hand causes the two spaced-apart rows of three or rows of four with beverage cans to be moved closer together and the distance to be reduced to approximately a value of zero, which on the other hand also effects the immersion and/or the latching of segments of the upper edges of the beverage cans at their upper lid regions into prepared slot-like recesses within the main surface.

If the width dimension of the article grouping should be considered, this is reduced in the packaging unit to a value which corresponds to a double article diameter or can diameter in its shell region. While the value of the width dimension is initially somewhat greater, due to the given distance, than twice the article or can diameter, it is reduced by the process of pushing in the folding region to the target value of twice the diameter.

For this purpose, the folding region can, for example, be pressed in a V-shape within the separating plane between the container rows and with a bent edge parallel to the first main axis downwards between the beverage cans, wherein at the transition edges to the main surface, which are each connected to each individual one of the slot-like recesses on both sides, it is possible to ensure prepared bent edges, perforations or the like for a defined chamfer.

The flanks, pointing on both sides to the halves of the main surface divided centrally by the folding region, of the flanks of the folding region deformed in a V-shape, pushed downward in a V-shape between the container rows, can enclose an opening angle in reasonable orders of magnitude between about 80° and about 150°. However, this value range for the opening angle is not to be understood as limiting, since the opening angle of the folding region deformed in a V-shape can be oriented, depending on suitability, toward the deformability of the used flat material of the packaging blank, toward the upper edge contour of the articles or beverage cans, toward the can shape or toward other boundary conditions. However, other contours of the deformed folding region are also conceivable, which deformed folding region does not necessarily have to be reshaped into a V-shape, but can, for example, also have a chamfer-like base with a defined curvature radius or a rectangular cross-sectional contour.

At opposite sides, the recesses can each detect circle segments of the edges at the upper end faces of the beverage cans with segment angles of approximately 40° . . . 60° (optionally also slightly more or less). In addition, the respective transitions from the main surface to the side surfaces can optionally be bent twice by approximately 45° in each instance, which as a whole results in the aforementioned bend angle of 90°. In this way, roof-shaped transitions are created in each instance, in which the recesses are located, with which the beverage cans can be latched in each instance.

Once the primary fixing device are activated in this way and the corresponding distances between the beverage cans are removed or the desired dimensions are produced for the bundle width, so that the corresponding contact lines between the previously spaced beverage cans in the two longitudinal rows are exactly at the mentioned separating plane, the secondary fixing device can be activated. The primary fixing device are realized by the beverage cans held relatively firmly in the packaging blank, as a result of which the relative positions of the beverage cans to one another are largely fixed. Since the beverage cans are fixed by their respective precise positioning within the recesses, at least at their upper rim sections on their lid regions relative to the packaging blank and relative to the other beverage cans or articles in the article grouping, they can hardly deviate there.

However, since the packaging blanks made of cardboard material normally used for the purpose described generally do not have a high degree of bending stiffness, initially only the positions of the beverage cans to one another are defined. However, this does not necessarily apply to their alignments in relation to the respective longitudinal central axes of the cylindrical articles or beverage cans, since these can be tilted relative to one another due to the flexibility of the packaging blank, wherein the lower regions, i.e., the base regions of the beverage cans, can spread apart from one another. In order to reliably prevent this undefined tilting of the beverage cans in the composite of the article grouping equipped with the packaging blank, secondary fixing device are provided which, like the primary fixing device, can equally be formed by the shaping and supplementary functional elements of the packaging blank as its integral components.

The side surfaces of the packaging blank which are applied laterally to the shell surfaces of the beverage cans on the longitudinal sides of the arrangement or article grouping form collar sections so to speak, which are held there when the secondary fixing device are used as intended and can preferably also be slightly prestressed. The secondary fixing device are activated by folding the strip sections around the shell surfaces of the beverage cans located at the opposite narrow sides of the article grouping and by fixing the at least slightly overlapping strip sections to one another, for example by bonding. Optionally, the overlapping strip sections can also be connected to one another in other ways, for example by a welded connection, by clamping or the like.

If a bonding is desired, this can be produced, for example, by prepared adhesive surfaces on the strip sections. Optionally, a sufficient amount of cold glue or hot glue can be applied to one of the strip sections or to both overlapping regions of the superimposed strip sections, which can provide a firm mechanical connection between the strip sections. In this way, the desired strapping sections, which hold the bundle or packaging unit together and fix the positions and also the alignments of the beverage cans to one another in the bundle unit, are formed from the strip sections, which are adhesively connected to one another.

The typical width of these strapping sections formed from the strip sections depends on the requirements, in particular the desired stability of the bundle or the packaging unit. A very thin and flexible packaging blank made of thick paper or thin cardboard will tend to require a collar section that is pulled down further and slightly wider strapping sections in order to be able to provide the desired mechanical stability of the packaging unit.

On the other hand, a sufficiently stable and mechanically resistant cardboard as packaging blank will allow the width of the strapping sections to be fixed at a value of approximately one quarter or less of the height of the cylindrical shell surfaces of the beverage cans held together in this way. There, the width of the strapping sections can be, for example, also less than one fifth of the respective height of the cylindrical shell surfaces of the beverage cans.

The strip sections of the variant of the packaging blank can optionally be in each instance of the same length, such that the packaging blank can also be designed to be mirror-symmetrical with respect to both the first main axis and the second main axis. However, alternative variants are also conceivable in which the strip sections can be designed in length designs deviating from one another, which is not to be explained in greater detail here, however, since it is not essential for the illustration of the central inventive concept.

In the following, the options are to be described briefly, to detect a current status during the production of the packaging units in order to be able to deduce a faultless or faulty state of a packaging unit on the basis of a comparison of the current status with a predeterminable target status.

The target values which specify the target status to be aimed for are the dimensions already explained in greater detail above, wherein the horizontal distance must first have a minimum value, provided the grouped articles are so-called slim or sleek cans which are more difficult to process than conventional beverage cans with indented lid and base regions. In order to be able to equip the cylindrical slim or sleek cans, which are usually continuously shaped from the base up to the lid region, with a packaging blank and to be able to latch them to the lid regions in order to produce the primary fixing elements with the cans, it is necessary for these to be arranged with a minimum distance at least with respect to an adjacent can which is spaced apart transversely to the transport direction.

This horizontal distance necessary for the production of the primary connecting elements is then eliminated in conjunction with the formation of the strapping sections which form the secondary fixing elements, so that a measured value of zero for the horizontal distance can serve as a criterion for a properly produced packaging unit with a sufficiently prestressed strapping band and thus for a qualitatively faultless bundle. At this distance value of zero, the horizontal bundle width has a defined maximum value which is below a predeterminable limit value. In this case, the adjacent articles or beverage cans touch in line contact, as a result of which a fixed mechanical cohesion and faultless secondary fixing device can be assumed.

However, if the measured horizontal distance is greater than zero, the horizontal bundle width also exceeds the prespecified maximum value, so that a non-faultless bundle is identified after detection of at least one of the two values. With such a packaging unit with the visible distance between the adjacent rows of cans, it must be doubted whether a sufficient or too low a band tension of the strapping section is given. Due to the non-completely contacting articles or beverage cans, the articles in the bundle composite can continue to move and at least partially spread apart from one another, which results in an unstable bundle that is to be regarded as faulty.

The measurement of the horizontal distance and/or the horizontal bundle width can, for example, take place optically, i.e., by a suitable optical detection device, which, depending on suitability, can be formed, for example, by a light barrier assembly or also by a camera with downstream image evaluation. However, the use of other detection devices that are not based on optical measuring principles is also conceivable. For example, the distance or width detection can also take place by ultrasound measurement or optionally also mechanically, wherein a mechanical detection of the distance can take place by a lever scanning or in a similar manner.

During a measurement, the optical detection device transmits an electrical output signal to a downstream evaluation circuit which, depending on the deviation of the output signal from a predetermined target value, can confirm a faultless packaging unit or can supply an error signal. If the evaluation circuit generates an error signal due to an excessively high measured value for the horizontal bundle width or for a distance value of the can rows of greater than zero, this can optionally be used for a corresponding system control, for example in order to remove or to eject the bundle recognized as faulty from the ongoing packaging process.

On the one hand, it can be ensured in the manner described that each individual bundle is checked for maintaining the predetermined target status. On the other hand, it can be ensured that only bundles recognized as a faultless bundles are available to the further packaging process, whereas bundles recognized as faulty are either marked accordingly in order to be manually removed, for example, or such faulty packs can be removed directly and preferably fully automatically from the running packaging process.

It is also conceivable to detect the horizontal width of the packaging unit by detecting the distance of the two articles located next to one another in the transport direction at the front thereof in their most widely spaced-apart positions of their outer sides. At the same time, this dimension corresponds to the bundle width at the narrow side of the packaging unit. The dimension for the bundle width should be below a limit dimension in the finished bundle, so that a greater value than this maximum value delivers an indication of articles that do not come completely into contact, whereby the articles in the bundle composite can continue to move and at least partially spread apart from one another. Such a bundle can also be considered to be unstable, so that it can be detected and separated out as a faulty bundle.

As in the case of the measurement of the horizontal distance, the bundle width can also be measured, for example, optically, by a light barrier assembly, by a camera and downstream image evaluation, by ultrasound measurement or optionally also mechanically, wherein here too the distance can be detected mechanically by a lever scanning or in a similar manner. In such a measurement variant, for example, pivoting levers are arranged in the transport path of the packaging units moved in the transport direction. As soon as the corresponding packaging unit passes through the pivoting levers, these are moved apart and each experience a defined deflection, which can be detected by suitable measurement transducers and can be transmitted as an electrical output signal to a downstream evaluation circuit, which in turn, depending on the deviation of the output signals from a predetermined target value, can confirm a faultless packaging unit or can deliver an error signal. In general, such a deviation is to be expected by a detected stronger deflection than at the target value for the bundle width, which is transmitted to the evaluation circuit as a correspondingly changed output signal.

If the evaluation circuit generates an error signal on the basis of an excessive deflection of the two pivoting levers and an excessively high measured value that is derived therefrom for the horizontal bundle width, this can be used optionally for a corresponding system control, for example in order to remove or to eject the bundle recognized as faulty from the ongoing packaging process.

At this juncture, it should not be mentioned separately that only one such probe sensor can optionally also be present in the form of a pivoting lever which can normally also supply the desired measured values for the bundle width. If two symmetrically operating pivoting levers are present on both sides of the transport path for the packaging units to be monitored, both pivoting levers expediently also provide corresponding output signals which are derived from the respective deflections. These two output signals are merged in the evaluation circuit and processed further in a suitable manner. The further processing takes place in the manner already explained above in the evaluation circuit.

### BRIEF DESCRIPTION OF THE FIGURES

Exemplary embodiments of the invention and their advantages are explained in more detail below with reference to the accompanying figures. The proportions of the individual elements relative to one another in the figures do not always correspond to the actual proportions, since some forms are simplified, while other forms are shown enlarged in relation to other elements for better illustration.

FIGS. 1A to 1F show schematic views of different individual components interacting with one another, which individual components can be converted and reshaped into packaging units, wherein a current status of the packaging units can be detected and compared with a target status.

FIGS. 2A and 2B show exemplary process steps for forming packaging units according to FIG. 1A to 1F by an embodiment variant of a handling tool.

FIGS. 3A to 3C show different views of the measurement data collected on the packaging units and the further processing thereof.

FIG. 4 shows an alternative variant of a packaging unit in schematic and perspective representation.

Identical reference numerals are used for identical elements of the invention or those having the same effect. Furthermore, for the sake of clarity, only reference signs are shown in the individual figures, which are required for the description of the respective figure. The illustrated embodiments are merely examples of how the measuring apparatus according to the invention or the method according to the invention can be configured, and they are non-limiting.

### DETAILED DESCRIPTION OF THE INVENTION

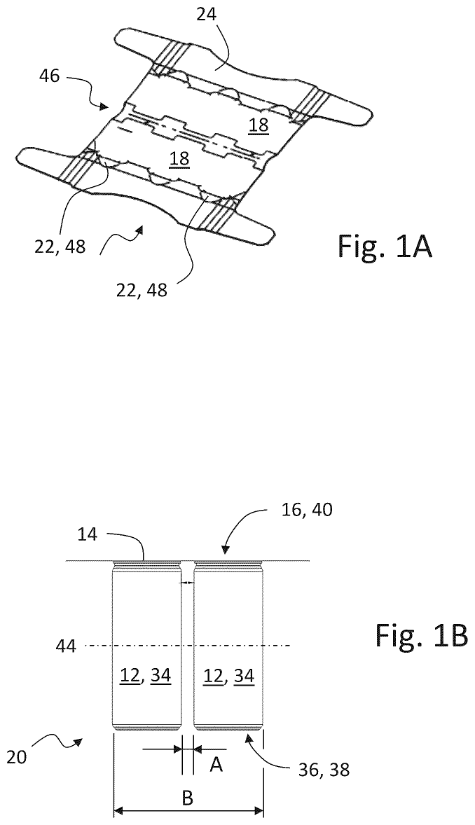

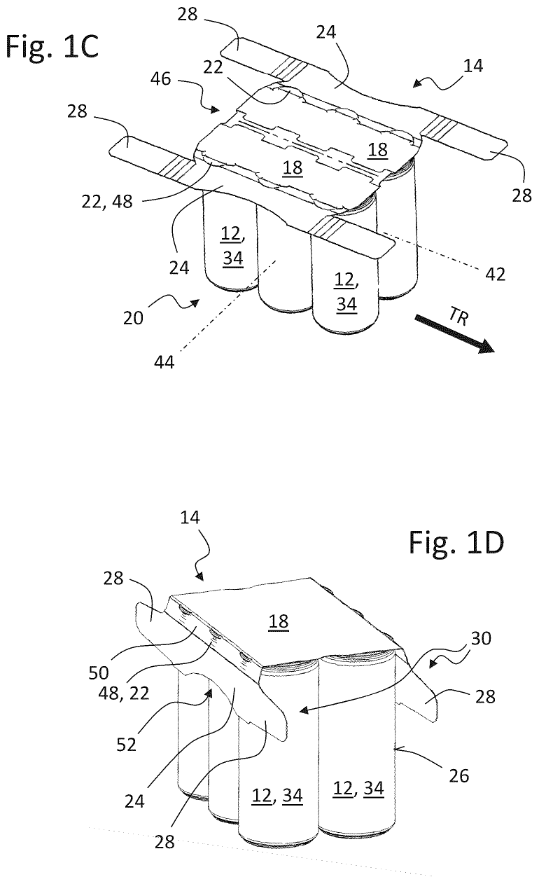

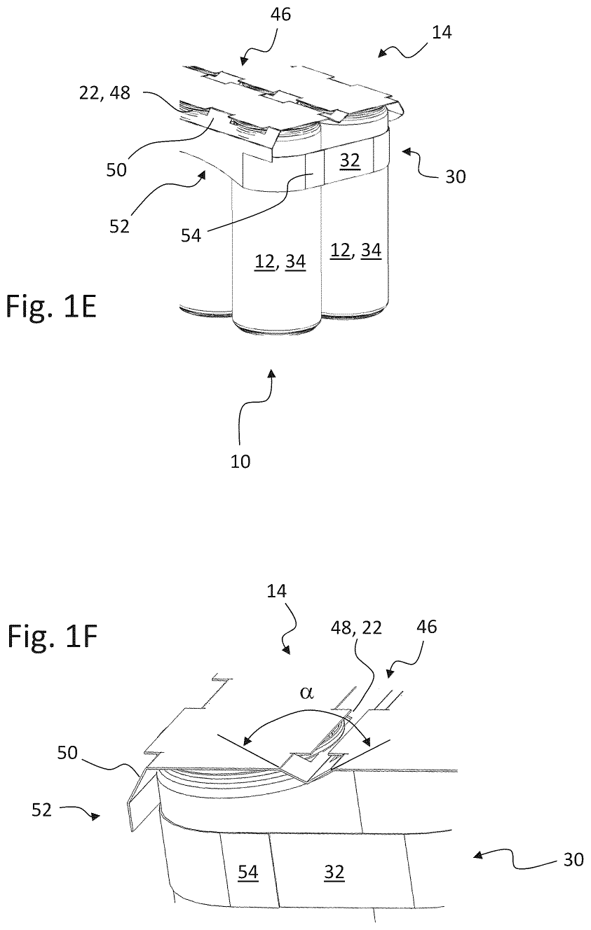

On the basis of the perspective and schematic views of FIGS. 1A and 1C to 1F and the schematic side view of FIG. 1B, the most important basic principles of the method according to the invention for producing packaging units 10 are to be illustrated firstly on the basis of an exemplary embodiment.

In addition, in this context, the measurement variables to be detected using the packaging units 10 produced are to be explained, which can serve as reasonable parameters in conjunction with the comparison of a current status with a desired target status. These are, in essence, distance dimensions which can be detected in a suitable manner and can be tapped from the packaging units 10, which is shown and illustrated by way of example below.

If packaging units 10 are mentioned in this context and in conjunction with the further description, but also the general statements made above, the likewise customary term “bundle” can optionally also be used instead. The term “packaging unit 10” chosen here, and almost without exception, is intended to refer to the finished unit, which can be handled as a complete unit, possibly also stackable unit and/or unit that can be purchased and used by the end customer in retail stores, formed of at least two articles and the packaging device mechanically combining them.

Optionally, it could also be mentioned that the packaging unit 10 is a composite comprising at least two primary packagings which are mechanically combined by at least one secondary packaging and can thus be considered as a bundle composite or as a packaging unit 10.

In the exemplary embodiment shown, the packaging units 10 assembled and fabricated by the production method described below comprise a total of six similar articles 12, which are held together in a rectangular arrangement by a flat packaging blank 14.

In the method, the packaging blank 14 (cf. FIG. 1A) is first placed and/or applied to the article grouping 20 with a main surface 18 covering the first or upper end faces 16 or lid sides of the article 12 grouped in the 3×2 rectangular arrangement (cf. FIGS. 1B and 1C).

With the placement and possibly already with the application of the packaging blank 14 onto the upper side of the article grouping 20, i.e. onto the upper end faces 16 of the grouped articles 12, connections between the articles 12 and primary fixing device 22 of the packaging blank 14 are simultaneously formed. In addition, the primary fixing device 22 to be explained in greater detail below define the positions of the articles 12 relative to one another in that the dimensioning of the main surface 18 of the packaging blank 14 and the positions of the fixing device 22 are coordinated with the dimensions of the articles 12 and of the article grouping 20 consisting of a plurality of articles 12.

After the packaging blank 14 has been placed on the upper side of the article grouping 20 (FIG. 1C), side surfaces 24 are folded over to both longitudinal sides of the article grouping 20 according to FIG. 1D and placed against shell surfaces 26 of the articles 12, but without following the curved contours of the shell surfaces 26.

In the exemplary embodiment shown, the articles 12 are in each instance similarly shaped cylindrical articles 12 with largely uniformly shaped and continuously cylindrically contoured shell surfaces 26. The upper end faces 16 and the bottom sides of the articles 12 can be circular and optionally curved in slightly concavely. However, this generally does not mean a general limitation to such articles 12, so that they can optionally also have non-circular cross sections and consequently differently shaped shell surface with a non-cylindrical contour, for example polygonal cross sections with rounded edges or similar other shape variants. Such articles 12 can in principle also be grouped in a comparable manner and combined into identical or very similar packaging units 10 by such packaging blanks 14, as explained here on the basis of the cylindrically shaped articles 12.

The side surfaces 24 in each instance form continuations of the main surface 18 of the packaging blank 14 and are located on both longitudinal sides of the main surface 18 in a symmetrical arrangement. Together with strip sections 28, on both side surfaces 24, that continue to both narrow sides of the side surfaces 26, the two side surfaces 24 adjacent to the main surface 18 of the packaging blank 14 are provided and designed to form secondary fixing device 30 in each instance, which interact with them when applied to the shell surfaces 26 of the articles 12.

By fixing overlapping end regions of the strip sections 28 to one another and/or by fixing them to the shell surfaces 26 of the articles 12, the secondary fixing device 30 are formed by strapping sections 32, as can be seen in the schematic perspective view of FIG. 1E and the perspective detailed view of FIG. 1F. There, the strapping sections 32 each surround defined regions of the shell surfaces 26 of the articles 12, and specifically on both opposite narrow sides of the article grouping 20.

The articles 12, which are fixed and held in position by the strapping sections 32, can only be swiveled or displaced minimally when the packaging unit 10 (FIG. 1E) is completed in this way, such that the secondary fixing device 30 thus fix the articles 12 within the packaging unit 10 in a substantially parallel alignment of their longitudinal central axes to one another.

As can be clearly seen in FIGS. 1A, 1C, and 1D, the strapping sections 32 of the secondary fixing device 30 (cf. FIGS. 1E and 1F) are formed by the strip sections 28 of the packaging blank 14, which extend the side surfaces 24 at both narrow sides in directions along the longitudinal extension directions of the side surfaces 24.

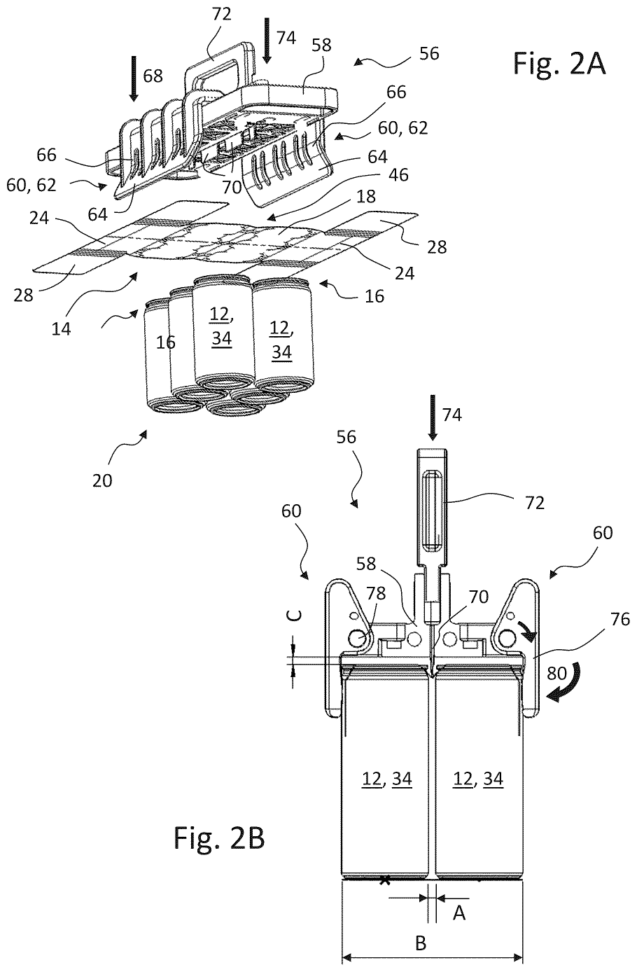

The folding over of the side surfaces 24 and the placement of the strip sections 28 by suitable handling devices and the reshaping to form the strapping sections 32, in which overlapping end regions are fixed to one another and/or to the shell surfaces 26 of the articles 12, is to be explained and illustrated by way of example with reference to FIGS. 2A and 2B.

As is already clear from the consideration of FIG. 1A to 1E, the articles 12 can in particular be beverage cans 34, which is why the articles 12 marked here are also denoted throughout with the reference sign 34 in the present context. The beverage cans 34 used here are, in particular, so-called slim cans or sleek cans, which are manufactured from a suitable metal sheet, in particular from a suitable aluminum alloy, which can take place in particular by a deep-drawing method and a subsequent joining method for placing the lid.

The beverage cans 34 illustrated in their typical contours in the schematic side view of FIG. 1B are shaped hollow-cylindrically and closed on all sides. They also each have a flat or slightly concave curved circular base region 36 on their lower end faces 38 and a mostly flat circular upper lid region 40 on the opposite end face. This upper lid region 40 forms the aforementioned upper end face 16 of the articles 12 formed by the beverage cans 34.

The flat or slightly concave curved base region 36 on the lower end face can typically be connected in one piece to the cylindrical shell surface 26, which can usually be realized by a deep-drawing process in the case of tin cans.

What in the present context is also referred to as the upper end face 16 of the article 12 is the upper lid region 40 of the corresponding beverage can 34. The lid itself can, for example, be connected to the upper rim of the cylindrical shell of the beverage cans 34 by crimping, such that the can 34 is closed on all sides. A tear-off lid or tear-off closure with a tear-off tab or the like may be incorporated into the lid, wherein scoring lines can be present as predetermined breaking points in the metal or aluminum sheet, which enable the tear-off closure to be opened to remove the liquid in the beverage can 34.

As FIG. 1B also clearly shows, the cylinder diameter in the region of the cylindrical shell surface 26 and the outer circular diameters of the base region 36 and of the lid region 40 of the beverage cans 34 shown are substantially the same or nearly the same, wherein the base region 36 and/or the lid region 40 can be slightly retracted or tapered relative to the cylindrical shell surface 26.

Such a can shape with an almost uniformly cylindrical outer contour from the base 36 to the lid 40 is a characteristic feature of such so-called slim cans or sleek cans, whereas conventional (standard) cans normally have significantly smaller diameters in the base and lid regions than in their cylindrical shell regions.

Therefore, when cans 34 or beverage cans 34 are referred to in the present context, this can in principle and in all cases mentioned mean such slim cans or sleek cans.

So-called upper gripping cardboard packages, which are known for combining standard cans and which have a number of openings for the standard cans to pass through, thus simultaneously define the positions of the cans within packaging units formed in this way. The gripping cardboard packages are normally pressed onto a set of standard cans from above, such that the lid region of the standard cans passes through an assigned opening. Often, the gripping cardboard package is anchored below the lid region of the standard cans, in particular in a region with a reduced cross section or in a constricted region just below the flanged edge, with which the lid is placed onto the upper edge region of the cylindrical shell region. Within a packaging unit produced thereby, the cans are arranged closely adjacently, normally with touching contact of their shell surfaces.

However, the use of such gripping cardboard packages in so-called slim cans or sleek cans, as can be realized here on the basis of the beverage cans 34, is hardly sensible. Since, with such cans 34, there is little or no difference between the diameter in the lid region 40 and the diameter in the cylindrical shell region 26, there is a lack of material between the openings of the gripping cardboard, such that the regions between the openings of adjacent cans 34 can easily tear out, as a result of which the gripping cardboard lacks the necessary stability.

For this reason, the articles 12 or beverage cans 34 of the article grouping 20 are spaced apart from one another initially, i.e. prior to the final shaping of the main surface 18 of the packaging blank 14, along at least one of the main horizontal axes of the article grouping 20. FIG. 1B illustrates this defined horizontal distance A of the respectively adjacent articles 12 or beverage cans 34 (here: slim or sleek can) in a direction parallel to the second main axis 44 of the article grouping 20 (cf. FIG. 1C).

As will be explained in even greater detail, this horizontal distance A simultaneously represents a dimension of a target status of the finished packaging unit 10 which, in the ideal state, should assume a value of zero as soon as the opposite strapping sections 32 according to FIGS. 1E and 1F are placed around the shell surfaces 26 of the articles 12 or beverage cans 34 located at the narrow sides of the article grouping 20 and joined there to one another, preferably by applying a certain strapping band tension. Such a defined strapping band tension can reliably ensure that the individual articles 12 or beverage cans 34 are fixedly in line contact with one another in the composite of the packaging unit 10 and do not develop any tendency to spread apart from one another in their lower base regions 36.

Instead of the horizontal distance dimension A, a bundle width B can optionally also be detected and regarded as a reasonable maximum for a target status to be aimed for. In order to detect this bundle width B, a distance between the shell surfaces 26 of the adjacent articles 12 or beverage cans 34 can be measured in their most widely spaced-apart positions, i.e. in the shown exemplary embodiment according to FIGS. 1B and 1C in a direction transverse to the first horizontal main axis 42 and parallel to the second horizontal main axis 44. The dimension B is also indicated in FIG. 1B.

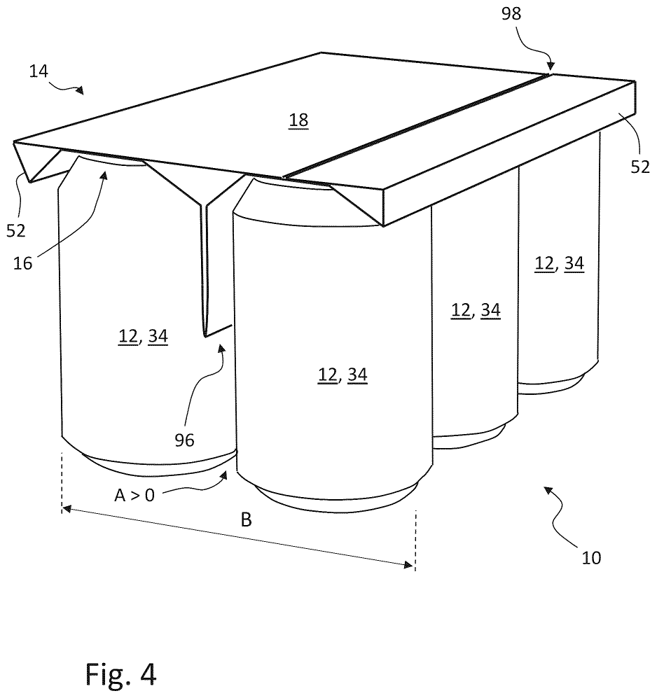

However, it should be noted that the shown dimension A should only assume a value of zero or approximately zero in the bundle variants, shown in FIG. 1A to 3C, of the packaging unit held together with the upper packaging blank 14 and strapping sections 32 arranged thereon, whereas in alternative bundle variants according to FIG. 4 it is not useful to set this measure to a target value of zero. In the case of the bundle variant shown there, such a value rather means an impermissible deviation which can supply an indication of a faulty bundle or a faulty packaging unit.

If, instead of the distance dimension A, a defined bundle width B is to be considered, this dimension in the bundle variants according to FIG. 1A to 3C corresponds exactly to twice the article or can diameter and should only be minimally larger, since otherwise it is questionable whether the strapping sections 32 are correctly arranged or connected and whether the required strapping band tension could be produced. On the other hand, an unusual measured value less than twice the article or can diameter would indicate deformed or pressed-in article or can shell surfaces 26, which would also be considered to be errors and could initiate a rejection process or could trigger another error message.

The two main axes 42 and 44 of the article grouping 20 are illustrated in FIG. 1C. Thus, in the embodiment variant of the 3×2 rectangular arrangement of the grouped articles 12 or beverage cans 34 shown there, a first main axis 42 runs parallel to the two rows, in each instance with three articles 12 or beverage cans 34 aligned one behind the other or standing one behind the other, while the second main axis 44, which is orthogonally thereto, runs transversely to such rows of three.

Both main axes 42 and 44 are normally oriented horizontally, since the article grouping 20 is usually equipped and/or conveyed with the packaging blank 14 in a defined direction of transport TR with the corresponding base regions 36 of the beverage cans 34 on suitable transport devices such as, for example, on horizontal conveyor devices. Therefore, the first main axis 42 runs parallel or in the direction of the transport direction TR (in FIG. 1C from left to right), such that the second main axis 44 is oriented transversely to the transport direction TR.

Thus, the horizontal distance A is also plotted parallel to the second main axis 44, as illustrated in FIG. 1B. In addition, the horizontal bundle width B is also plotted parallel to the second main axis 44. In order to be able to ensure the desired reliable fixing of the articles 12 or beverage cans 34 within the packaging blank 14 prepared for this purpose and in particular pre-punched, although, in the case of the slim or sleek cans shown here, which form the beverage cans 34, there is insufficient space for this between the upper lid regions 40 of the adjacent beverage cans 34, it is necessary in the initial phase of equipping the article grouping 20, between the two rows of three of beverage cans 34 parallel to the first main axis 42, to produce the defined distance A or a minimum dimension for a defined bundle width B.

In the schematic side view of FIG. 1B, such horizontal distance A is shown by way of example between two adjacent beverage cans 34, which represent each of the pairings of articles 12 or beverage cans 34 transverse to the first major axis 42 recognizable in FIGS. 1C and 1D.

This arrangement with rows of beverage cans 34 spaced apart by the horizontal distance A (greater than zero) makes it possible to press a folding region 46 of the packaging blank 14 between the upper lid regions 40 of the pairs of beverage cans 34 initially spaced apart by the distance A, as a result of which such beverage cans 34 are simultaneously brought closer together in pairs until their shell surfaces 26 are in line contact.

The folding region 46 is located in the main surface 18 of the packaging blank 14 and divides it into two rectangular halves (cf. FIGS. 1A and 1B), which are located on either side of a vertical separating plane (not shown separately here), which is located between the pairs of beverage cans 34 spaced apart by the horizontal distance A. The first main axis 42 lies within such vertical separating plane, while the second main axis 44 cuts perpendicularly through the vertical separating plane.

The folding region 46 serves to form the primary fixing device 22 by which the articles 12 or beverage cans 34 are held in the composite of the packaging unit 10 as soon as the packaging blank 14 is reshaped, pressed and folded in sections in the manner described here, and the secondary fixing device 30, which are formed here by the strapping sections 32, are brought into position and connected to one another in the intended manner.

After placing the packaging blank 14 (cf. FIG. 1A) with its main surface 18 onto the upper end faces 16 of the articles 12 or beverage cans 34 (cf. FIG. 1C) brought into the article grouping 20 in rectangular arrangement, which are, however, spaced apart from one another in pairs again according to FIG. 1B by the distance A, the side surfaces 24 of the packaging blank 14 projecting laterally beyond the opposite longitudinal sides of the article grouping 20 are folded down laterally so that they rest against the corresponding shell surfaces 26 of the beverage cans 34 (cf. FIG. 1D).

The side surfaces 24 of the packaging blank 14 are folded by approximately 90°. Optionally, the side surfaces 24 can also be folded in two stages by less than 90° in each instance, so that a roof-shaped transition 50 forms at a collar section 52, as is shown by way of example in FIGS. 1D, 1E and 1F.

In the present context, the extensions of the two side surfaces 24 that project in the direction of both narrow sides of the main surface 18 of the packaging blank 14 clearly over the length of the main surface 18 are also referred to as strip sections 28 or as extended strip sections 28, since they have to fulfill a specific function in conjunction with the production and the formation of the secondary fixing elements 30, as can be seen with reference to FIGS. 1E and 1F.

The strip sections 28 are not normally attached subsequently to the side surfaces 24, but are an integral component of the side surfaces 24, wherein the strip sections 28 as well as all other components and functional elements of the packaging blank 14 may be produced from a cardboard sheet or similar flat packaging material in a single or possibly multi-stage punching process.

Since the packaging blank is generally a flat and sufficiently stable cardboard, the contours of the packaging blank 14 shown in the representations of FIG. 1A to 1F can advantageously be produced by a punching process, wherein the packaging blank 14 can optionally be printed either beforehand in a colored or graphic manner in order to already provide a ready-to-use packaging unit 10 after application to the article grouping 20.

After the side surfaces 24 have been folded over according to FIG. 1D, wherein pre-folded and/or perforated or otherwise predetermined bent edges can be practically used on the longitudinal edges of the main surface 18 of the packaging blank 14, the packaging blank is further processed in two phases in order to achieve the final state of the packaging unit 10 according to FIG. 1E (and according to the detail view in FIG. 1F).

This two-phase further processing comprises pressing the main surface 18 of the packaging blank 14 over the entire length of the folding region 46 running centrally through the main surface 18, which, on the one hand, causes the two spaced-apart rows of three with beverage cans 34 to be moved closer together and the distance A to be reduced to approximately a value of zero, which on the other hand also effects the immersion and/or the latching of segments of the upper edges of the beverage cans 34 at their upper lid regions 40 into prepared slot-like recesses 48 within the main surface 18 (cf. FIG. 1F).

If the dimension B according to FIG. 1B should be considered, this is reduced in the shown variant of the packaging unit 10 to a value which corresponds to a double article diameter or can diameter in its shell region. While the value B is initially somewhat greater, due to the given distance A, than twice the article or can diameter, it is reduced by the process of pushing in the folding region 46 to the target value of twice the diameter.

For this purpose, the folding region 46 can, for example, in the shown form be pressed in a V-shape within the separating plane between the container rows and with a bent edge parallel to the first main axis 42 downwards between the beverage cans 34, wherein at the transition edges to the main surface 18, which are each connected to each individual one of the slot-like recesses 48 on both sides, it is possible to ensure prepared bent edges, perforations or the like for a defined chamfer.

The flanks, pointing on both sides to the halves of the main surface 18 divided centrally by the folding region 46, of the flanks of the folding region 46 deformed in a V-shape, pushed downward in a V-shape between the container rows, can enclose an opening angle a in reasonable orders of magnitude between about 80 and about 150 angular degrees. In the exemplary embodiment shown in FIGS. 1E and 1F, this opening angle a is at a value of approximately 120°.

However, this value for the opening angle a is not to be understood as limiting, since the opening angle of the folding region 46 deformed in a V-shape can be oriented, depending on suitability, toward the deformability of the used flat material of the packaging blank 14, toward the upper edge contour of the articles 12 or beverage cans 34, toward the can shape or toward other boundary conditions. However, other contours of the deformed folding region 46 are also conceivable, which deformed folding region does not necessarily have to be reshaped into a V-shape, but can, for example, also have a chamfer-like base with a defined curvature radius or a rectangular cross-sectional contour.

At opposite sides, the recesses 48 can each detect circle segments of the edges at the upper end faces 16 of the beverage cans 34 with segment angles of approximately 40° . . . 60° (optionally also slightly more or less). As can be seen in FIGS. 1E and 1F, the respective transitions from the main surface 18 to the side surfaces 24 can also optionally be bent twice by approximately 45° in each instance, which as a whole results in the aforementioned bend angle of 90°. In this way, roof-shaped transitions 50 are created in each instance, in which the recesses 48 are located, with which the beverage cans 34 can be latched in each instance.

Once the primary fixing device 22 are activated in this way and the corresponding distances A between the beverage cans 34 are removed or the desired dimensions are produced for the bundle width B, so that the corresponding contact lines between the previously spaced beverage cans 34 in the two longitudinal rows are exactly at the mentioned separating plane, the secondary fixing device 30 can be activated. The primary fixing device 22 is realized by the beverage cans 34 held relatively firmly in the packaging blank 14, as a result of which the relative positions of the beverage cans 34 with respect to one another are largely fixed. Since the beverage cans 34 are fixed by their respective precise positioning within the recesses 48, at least at their upper rim sections on their lid regions 40 relative to the packaging blank 14 and relative to the other beverage cans 34 or articles 12 in the article grouping 20, they can hardly deviate there.

However, since the packaging blanks 14 made of cardboard material normally used for the purpose described generally do not have a high degree of bending stiffness, initially only the positions of the beverage cans 34 to one another are defined. However, this does not necessarily apply to their alignments in relation to the respective longitudinal central axes of the cylindrical articles 12 or beverage cans 34, since these can be tilted relative to one another due to the flexibility of the packaging blank 14, wherein the lower regions, i.e., the base regions 36 of the beverage cans 34, can spread apart from one another.

In order to reliably prevent this undefined tilting of the beverage cans 34 in the composite of the article grouping 20 equipped with the packaging blank 14, the invention provides for secondary fixing device 30 which, like the primary fixing device 22, can equally be formed by the shaping and supplementary functional elements of the packaging blank 14 as its integral components.

The side surfaces 24 of the packaging blank 14 which are applied laterally to the shell surfaces 26 of the beverage cans 34 on the longitudinal sides of the arrangement or article grouping 20 form collar sections 52 so to speak, which are held there when the secondary fixing device 30 are used as intended and can preferably also be slightly prestressed. The secondary fixing device 30 is activated by folding the strip sections 28 around the shell surfaces 26 of the beverage cans 34 located at the opposite narrow sides of the article grouping 20 and by fixing the at least slightly overlapping strip sections 28 to one another, for example by bonding 54. Optionally, the overlapping strip sections 28 can also be connected to one another in other ways, for example by a welded connection, by clamping or the like.

If a bonding 54 is desired, this can be produced, for example, by prepared adhesive surfaces on the strip sections 28. Optionally, a sufficient amount of cold glue or hot glue can be applied to one of the strip sections 28 or to both overlapping regions of the superimposed strip sections 28, which can provide a firm mechanical connection between the strip sections 28.

In this way, the desired strapping sections 32, which hold the bundle or packaging unit 10 together and fix the positions and also the alignments of the beverage cans 34 to one another in the bundle unit, are formed from the strip sections 28, which are adhesively connected to one another.

The typical width of these strapping sections 32 formed from the strip sections 28 depends on the requirements, in particular the desired stability of the bundle or the packaging unit 10. A very thin and flexible packaging blank 14 made of thick paper or thin cardboard will tend to require a collar section 52 that is pulled down further and slightly wider strapping sections 32 in order to be able to provide the desired mechanical stability of the packaging unit 10.

On the other hand, a sufficiently stable and mechanically resistant cardboard as packaging blank 14 will allow the width of the strapping sections 32 to be fixed at a value of approximately one quarter or less of the height of the cylindrical shell surfaces 26 of the beverage cans 34 held together in this way, which is shown by way of example by the variant in FIG. 1A to 1F. There, the width of the strapping sections 32 is even less than one fifth of the respective height of the cylindrical shell surfaces 26 of the beverage cans 34.

The strip sections 28 of the variant of the packaging blank 14 according to FIG. 1A and FIG. 1C are in each instance of the same length, such that the packaging blank 14 is also designed to be mirror-symmetrical with respect to both the first main axis 42 and the second main axis 44. However, alternative variants are also conceivable in which the strip sections 28 can be designed in length designs deviating from one another, which is not to be explained in greater detail here, however, since it is not essential for the illustration of the central inventive concept.

The schematic and perspective view of FIG. 2A and the schematic side view of FIG. 2B illustrate by way of example the use of different embodiment variants of tools for applying such a packaging blank 14 made of cardboard or another suitable flat packaging material, as previously explained with reference to FIG. 1A to 1F, to an article assembly 20 which, in turn, is formed by a total of six beverage cans 34 in a 2×3 rectangular arrangement.

For the sake of completeness, however, it should be noted at this juncture that FIGS. 2A and 2B substantially only show the steps of placing a packaging blank 14 with its main surface 18 on the upper end faces 16 of the cylindrical articles 12 formed by beverage cans 34, the folding over of the side surfaces 24 of the packaging blank 14 and the pressing of the folding region 46 running centrally through the upper main surface 18 of the packaging blank 14 and thus the formation of the primary fixing device 22. By contrast, the handling and design of the secondary fixing device 30, formed here by the strip sections 28 to be connected to one another as strapping sections 32 (cf. in this regard FIGS. 1E and 1F), is not shown.

FIG. 2A for example shows a schematic perspective view obliquely from below of the article arrangement 20 with the total of six beverage cans 34 brought into rectangular arrangement, above which the pre-punched and still non-folded packaging blank 14 is located, but which is still spaced apart from the upper end faces 16 of the beverage cans 34. Above the packaging blank 14 and at a distance therefrom is a conceivable embodiment variant of a handling tool 56, which has a base plate 58 acting as a carrier component, which corresponds to the dimensions and the size of the packaging blank 14, but in particular to the dimensions of the main surface 18 of the packaging blank 14. The base plate 58 should have at least the dimensions of the main surface 18, but this main surface 18 can optionally also protrude over one side or over a plurality of sides or points.

Folding tools 60, which here are formed by collar-like stripping tools 62 rigidly anchored to the base plate 58 with beveled lower longitudinal edges 64, are located on each of the two longitudinal sides of the variant of the handling tool 56 shown in FIG. 2A. The lower longitudinal edges 64, which are in each instance beveled towards the outer side of the base plate 58, are therefore spaced further apart from one another than the flanks 66 of the stripping tools 62 arranged above and located closer to the base plate 58.

The mutually parallel flanks 66 of the stripping tools 62, which are arranged on both longitudinal sides of the base plate 58 and point downward from there, have an inner distance from one another, which corresponds approximately to the width of two beverage cans 34 standing next to one another, so that they can ensure a folding over and pressing of the side surfaces 24 when the handling tool 56 is placed in the feed direction 68 when the base plate 58 is lowered onto the packaging blank 14 and/or is placed there. The lower longitudinal edges 64, spreading apart from one another downward, of the flanks 66 of the stripping tools 62 extending in such a way, also ensure a gentle folding over and an exact guidance of the side surfaces 24 when the base plate 58 approaches the main surface 18 of the packaging blank 14 or when placing the base plate 58.

From the underside of the base plate 58, in the same direction as the stripping tools 62, a blade-like folding punch 70 projects further, which ensures the pressing in of the folding region 46 within the main surface 18 of the packaging blank 14 as soon as the base plate 58 is either placed onto the packaging blank 14 or is located above the packaging blank 14 at a defined vertical distance C (cf. in this regard FIG. 2B).

The folding punch 70, which preferably corresponds to the dimensions and in particular to the length of the folding region 46 extending from a narrow side to the opposite narrow side of the main surface 18 of the packaging blank 14, presses the packaging blank 14 in the intended region—this is the folding region 46—between the rows of three of the beverage cans 34, which are initially still spaced apart from one another by the horizontal distance A, thereby activating the primary fixing device 22 (together with the folding over of the side surfaces 24) and reducing the horizontal distance A to a value of zero or approximately zero, so that all of the beverage cans 34 are in line with their shell surfaces 26.

Optionally, the blade-like folding punch 70 can be rigidly and immovably anchored in the base plate 58 of the handling tool 56, as this is indicated by FIG. 2A and the embodiment variant of the handling tool 56 shown there.

Likewise conceivable according to FIG. 2B is a stroke movement of the folding punch 70 that is enabled transversely to the underside surface of the base plate 58 and that, depending on the embodiment variant, can thus be moved downward out of the base plate 58 by an adjusting lever 72 in the stroke direction 74 by a defined stroke in order to be able to push the folding region 46 deeper between the adjacent can rows.

However, if the folding punch 70 cannot perform any relative movements in the stroke direction 74 relative to the base plate 58 (cf. FIG. 2A), the adjusting lever 72 serves to guide the entire handling tool 56 in conjunction with the placement and shaping of the packaging blank 14.

In the variant of the handling tool 56 shown in schematic side view in FIG. 2B, the folding tools 60 are formed by pivot brackets 76 hinged to both sides of the base plate 58 and pivotably mounted there, which, according to FIG. 2B, in a downwardly pivoted position fold the side surfaces 24 downward about a folding angle of approximately 90° with respect to the main surface 18 of the packaging blank 14 and can apply them to the shell surfaces 26 of the articles 12 or beverage cans 34.

The two parallel pivot axes 78, about which the two pivot brackets 76 can in each instance swivel, lie slightly above a plane that is defined by the packaging blank 14 placed on the upper end faces 16 of the articles 12 of the article grouping 20. In addition, the pivot axes 78 run parallel to the bent edges between the main surface 18 and the side surfaces 26 and thus also run parallel to the first main axis 42 (cf. in this regard FIG. 1C).

The possible pivoting movements 80, which the two pivot brackets 76 can each carry out, in order to apply the side surfaces 24 connected by bent edges to the main surface 18 of the packaging blank 14 around and to the shell surfaces 26 of the articles 12 or beverage cans 34 are indicated in the schematic side view of FIG. 2B by corresponding direction arrows.

As can also be seen from the schematic side view of FIG. 2B, the base plate 58, in the variant of the handling tool 56 shown here, acts as a guide and bearing for the folding punch 70 movable in the stroke direction 74.

In FIG. 2B, it can also be clearly seen that the base plate 58 remains removed from the main surface 18 by a defined vertical distance C and is not placed thereon, as a result of which friction effects and other unfavorable effects when the packaging blank 14 is pressed onto the upper end faces 16 of the beverage cans 34, can be avoided during their latching in the slot-like recesses 48 and when folding down the side surfaces 24. This vertical distance C thus ensures that the packaging blank 14, during all shaping processes, slides on the upper end faces 16 of the beverage cans 34 in the article grouping 20 and can perform relative movements which can occur in conjunction with the shaping processes described here.

This also applies to the activation of the blade-like folding punch 70, which passes through a corresponding recess in the base plate 58 and, by actuating the adjusting lever 72, presses on the folding region 46 in a stroke direction 74 aligned perpendicularly to the surfaces of the base plate 58 and the main surface 18 and presses it between the two adjacent rows of cans (cf. FIG. 2B). As a result, the mutually facing segments of the upper lid regions 40 of the beverage cans 34 are simultaneously pushed into the corresponding slot-like recesses 48 on both longitudinal sides of the folding region 46. Such latching processes form part of the primary fixing device 22 already mentioned several times.

FIG. 2B also shows that by this stroke movement of the folding punch 70 in the drawn stroke direction 74 downward and by the folding of the folding region 46 of the packaging blank 14, the can rows previously distanced from one another by the horizontal distance A approach one another, which is illustrated by the reduced distance A compared to the representation in FIG. 1B. The same applies to the bundle width B illustrated in FIG. 2B, which is hereby also necessarily reduced to a smaller value.

In principle, it would be possible to combine the downwardly pressing blade-like folding punch 70, which pulls the can rows against one another during the pressing of the folding region 46 between the two adjacent can rows and reduces or cancels the horizontal distance A between them, with the pivoting movements 80, shown in FIG. 2B, of the pivot brackets 76, as a result of which the pivot brackets 76 are advanced to the longitudinal sides of the article grouping 20 after the two side surfaces 24 of the packaging blank 14 have been folded down, such that they can also contribute to reducing or canceling the distance A between the adjacent can rows.

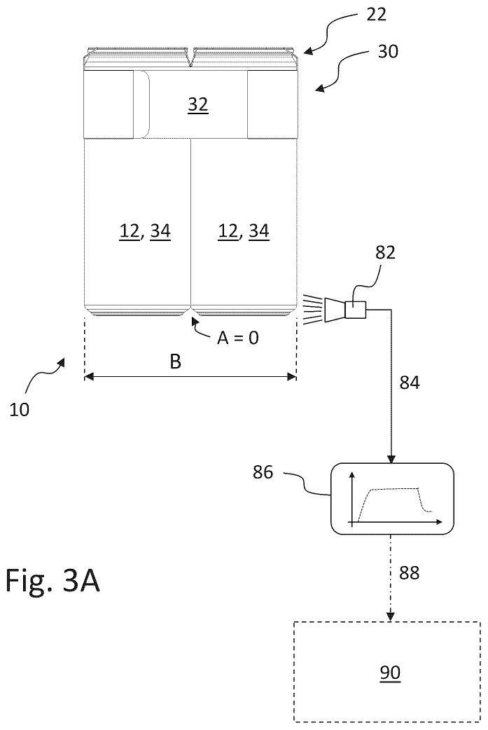

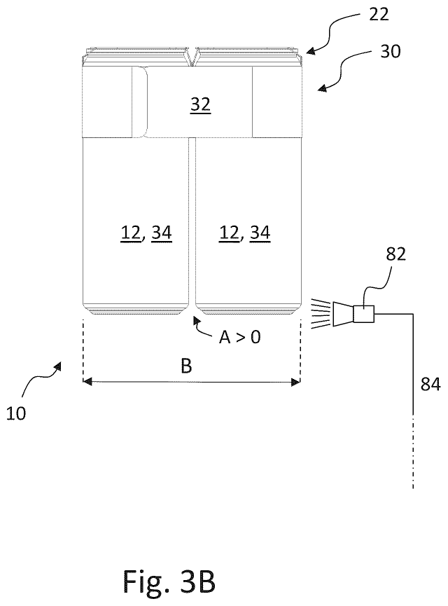

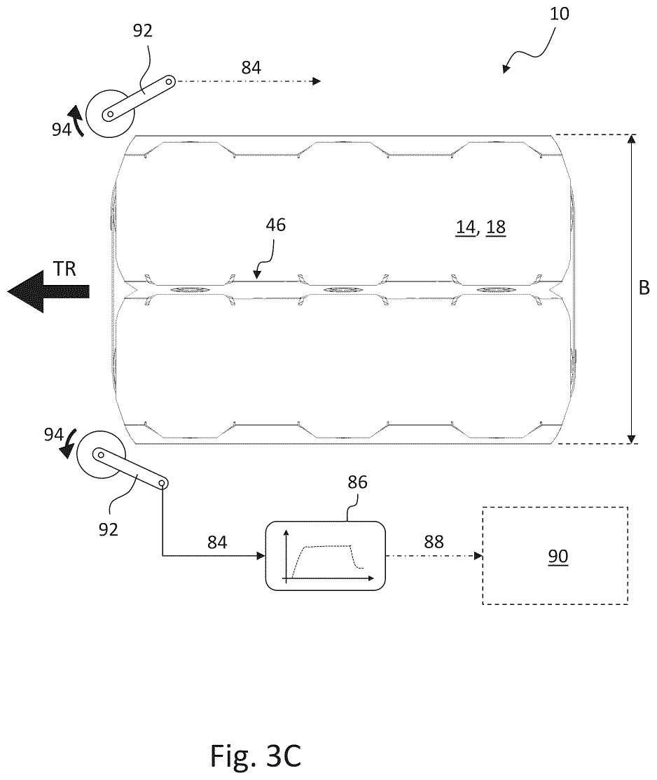

The two schematic side views as per FIGS. 3A and 3B and also the schematic plan view as per FIG. 3C again show the options for detecting a current status during the production of the packaging units 10 in order to be able to deduce a faultless or faulty state of a packaging unit 10 on the basis of a comparison of the current status with a predeterminable target status.

The target values which specify the target status to be aimed for are the dimensions A and/or B already explained in greater detail above, wherein the horizontal distance A must first have a minimum value (cf. FIG. 1B), provided the grouped articles 12 are so-called slim or sleek cans 34 which are more difficult to process than conventional beverage cans with indented lid and base regions. In order to be able to equip the cylindrical slim or sleek cans 34, which are usually continuously shaped from the base 36 up to the lid region 40, with a packaging blank 14 and to be able to latch them to the lid regions 40 in order to produce the primary fixing elements 22 with the cans 34, it is necessary for these to be arranged with a minimum distance A at least with respect to a neighboring can 34 which is spaced apart transversely to the transport direction TR.

This horizontal distance A necessary for the production of the primary connecting elements is then eliminated in conjunction with the formation of the strapping sections 32 which form the secondary fixing elements 30, so that a measured value of zero for the horizontal distance A can serve as a criterion for a properly produced packaging unit 10 with a sufficiently prestressed strapping band and thus for a qualitatively faultless bundle 10.

Such a bundle or such a faultless packaging unit 10, in which the horizontal distance A has a value of zero, is shown by way of example in FIG. 3A. In this case, the horizontal bundle width B has a defined maximum value which is below a predeterminable limit value. In this case, the adjacent articles 12 or beverage cans 34 touch in line contact, as a result of which a fixed mechanical cohesion and faultless secondary fixing device 30 can be assumed.

However, if according to FIG. 3B the measured horizontal distance A is greater than zero, the horizontal bundle width B also exceeds the prespecified maximum value, so that consequently a non-faultless bundle 10 is identified after detection of at least one of the two values A and/or B in the case as shown by way of example in FIG. 3B. With such a packaging unit 10 with the visible distance A between the adjacent rows of cans, it must be doubted whether a sufficient or too low a band tension of the strapping section 32 is given. Due to the non-completely contacting articles 12 or beverage cans 34, the articles 12 in the bundle composite can continue to move and at least partially spread apart from one another, which results in an unstable bundle 10 that is to be regarded as faulty.

The measurement of the horizontal distance A and/or the horizontal bundle width B can, for example, take place optically, i.e., by a suitable optical detection device 82, as is indicated only schematically in FIGS. 3A and 3B. Depending on suitability, this optical detection device 82 can be formed, for example, by a light barrier assembly or also by a camera with downstream image evaluation.

However, the use of other detection devices that are not based on optical measuring principles is also conceivable. For example, the distance or width detection can also take place by ultrasound measurement or optionally also mechanically, wherein a mechanical detection of the distance can take place by a lever scanning or in a similar manner.

As can be seen in FIG. 3A, the optical detection device 82 transmits an electrical output signal 84 to a downstream evaluation circuit 86 which, depending on the deviation of the output signal 84 from a predetermined target value, can confirm a faultless packaging unit or can supply an error signal 88. If the evaluation circuit 86 generates an error signal 88 due to an excessively high measured value for the horizontal bundle width B or for a distance value of the can rows of greater than zero (A>0; cf. FIG. 3B), this can optionally be used for a corresponding system control 90, for example in order to remove or to eject the bundle recognized as faulty from the ongoing packaging process.

On the one hand, it can be ensured in the manner described that each individual bundle is checked for maintaining the predetermined target status. On the other hand, it can be ensured that only bundles recognized as a faultless bundles are available to the further packaging process, whereas bundles recognized as faulty are either marked accordingly in order to be manually removed, for example, or such faulty packs can be removed directly and preferably fully automatically from the running packaging process.

Since the measuring assembly between FIGS. 3A and 3B does not fundamentally differ, the schematic representation of FIG. 3B does not dispense with a repeated image of the components receiving the output signal 84, but rather indicates the further processing only by the interrupted line of the signal line for the output signal 84.

It is also conceivable, according to FIG. 3C, to detect the horizontal width B of the packaging unit 10 by detecting the distance of the two articles 12 located next to one another in the transport direction TR at the front thereof in their most widely spaced-apart positions of their outer sides. At the same time, this dimension corresponds to the bundle width B at the narrow side of the packaging unit 10. The dimension for the bundle width B should be below a limit dimension in the finished bundle 10, so that a greater value for B than this maximum value delivers an indication of articles 12 that do not come completely into contact, whereby the articles 12 in the bundle composite can continue to move and at least partially spread apart from one another. Such a bundle 10 can also be considered to be unstable, so that it can be detected and separated out as a faulty bundle 10.

As in the case of the measurement of the horizontal distance A, the bundle width B can also be measured, for example, optically, by a light barrier assembly, by a camera and downstream image evaluation, by ultrasound measurement or optionally also mechanically, wherein here too the distance can be detected mechanically by a lever scanning or in a similar manner.

The schematic plan view of FIG. 3C illustrates a measurement variant with such pivoting levers 92 which are arranged in the transport path of the packaging units 10 moved in the transport direction TR. As soon as the corresponding packaging unit 10 passes through the pivoting levers 92, these are moved apart and each experience a defined deflection 94, which can be detected by suitable measurement transducers (not shown here) and, comparably to the circuit shown in FIG. 3A, can be transmitted as an electrical output signal 84 to a downstream evaluation circuit 86, which in turn, depending on the deviation of the output signals 84 from a predetermined target value, can confirm a faultless packaging unit or can deliver an error signal 88. In general, such a deviation is to be expected by a detected stronger deflection 94 than at the target value for the bundle width B, which is transmitted to the evaluation circuit 86 as a correspondingly changed output signal 84.

If the evaluation circuit 86 generates an error signal 88 on the basis of an excessive deflection 94 of the two pivoting levers and an excessively high measured value that is derived therefrom for the horizontal bundle width B, this can be used optionally for a corresponding system control 90, for example in order to remove or to eject the bundle recognized as faulty from the ongoing packaging process.

At this juncture, it should not be mentioned separately that only one such probe sensor can optionally also be present in the form of one of the shown pivoting levers 92 which can normally also supply the desired measured values for the bundle width B. If, according to the depiction as per FIG. 3C, two symmetrically operating pivoting levers 94 are present on both sides of the transport path for the packaging units 10 to be monitored, both pivoting levers 94 expediently also provide corresponding output signals 84, which are derived from the respective deflections 94. These two output signals 84 are fused in the evaluation circuit 86 and processed further in a suitable manner, for which reason, in the upper pivoting lever 92, which is located in the transport direction TR of the packaging unit 10 on its right longitudinal side, only the output signal 84 is indicated with an interrupted arrow. The further processing takes place in the manner described in the evaluation circuit 86.

Since, in addition to the variant of packaging units 10 shown in FIG. 1A to 3C, there are further packaging units 10 with packaging blanks 14 made of flat cardboard material, with which a plurality of articles 12 or beverage cans 34 can be mechanically held together in a bundle composite, such an alternative bundle variant should be explained in greater detail with reference to the schematic perspective view of FIG. 4, especially since other useful measured values exist there for the assessment of a deviation of a measured current status from a desired target status.

Thus, the packaging unit 10 shown here has a clearly different structure than the variant of the packaging unit 10 previously shown in FIG. 1A to 3C. In contrast to this previously shown packaging unit 10, in the variant according to FIG. 4, no strapping section is provided, but the articles 12, which are in turn formed by cylindrical beverage cans 34, are held completely by a multiply folded packaging blank 14 and are surrounded in the upper sections of their shell surfaces 26 by a folded-over collar section 52.

Since, in addition, a double-folded separating section 96 of the packaging blank 14 projects relatively far between the two rows of articles and has a material thickness which is not negligible there, this packaging unit 10 has a somewhat greater width than the packaging unit shown previously with the strapped articles 12. The width dimension B thus results from twice the can diameter in the region of its cylindrical shell surfaces 26 plus twice the material thickness of the packaging blank 14, which can typically consist of a sufficiently stable cardboard material.

At the flat main surface 18 covering the upper end faces of the beverage cans 34, a separating joint 98 can be seen, on which upper cover surface sections of the main surface 18 are subdivided and glued to the flat sections of the correspondingly folded sections of the packaging blank 14 that lie underneath. Such a packaging unit 10 is produced by multiple folding of the packaging blank 14 about fold edges, which all are aligned parallel to the longitudinal sides of the article grouping formed by a total of six compiled in the rectangular arrangement.

In particular due to the mentioned material thickness of the separating section 96 projecting between the two rows of three with the articles 12, in the variant of the packaging unit 10 according to FIG. 4, a faulty bundle can be detected when the horizontal distance A has a value of zero or approximately zero, since in this case an indication is given that the separating section 96 of the packaging blank 14, which is normally protruding between the rows of articles, is missing and thus a faulty bundle could be provided with insufficient mechanical cohesion of the articles 12.

The optical ultrasound scanning or mechanical scanning of the packaging units 10 for determining the bundle width B and/or the distance A between the article rows can take place in the same way as already described above with reference to the representations of FIG. 3A to 3C.

The following is given as a supplementary note to the above statements. If, in the context of the embodiment variants shown in the figures and their descriptions above, reference is also made often or also generally to “schematic” representations and views, this means by no means that the figure representations and their description are to be of subordinate importance with regard to the disclosure of the invention. A person skilled in the art is certainly able to derive sufficient information from the schematically and abstractly drawn representations that will make it easier for the person skilled in the art to understand the invention without being confused in any way by the drawn and possibly not exactly true-to-scale proportions of parts of the packaging units or the measuring assembly, respective details thereof or other drawn elements. Rather, the figures enable the skilled person as the reader to derive a better understanding of the inventive idea—which has been formulated in more general and/or more abstract terms in the claims and in the general part of the description, at least with regard to some aspects—on the basis of the more specifically explained implementations of the method according to the invention and the more specifically explained structure of the measuring assembly according to the invention.

The invention has been described with reference to a preferred embodiment. However, it is conceivable for a person skilled in the art that modifications or changes can be made to the invention without departing from the scope of protection of the following claims.

List of Reference Signs

| | |
|---|---|
| 10 | packaging unit, bundle |
| 12 | article |
| 14 | packaging blank |
| 16 | upper end face |
| 18 | main surface |
| 20 | article grouping, arrangement, article arrangement |
| 22 | primary fixing device, primary connecting device |
| 24 | side surface |
| 26 | shell surface |
| 28 | strip section |
| 30 | secondary fixing device, secondary connecting device |
| 32 | strapping section |
| 34 | beverage can, can |
| 36 | base region, lower base region, can base |
| 38 | lower end face |
| 40 | lid region, upper lid region, can lid |
| 42 | first main axis (of the article grouping) |
| 44 | second main axis (of the article grouping) |
| 46 | folding region |
| 48 | recess, slot-like recess |
| 50 | roof-shaped transition |
| 52 | collar section |
| 54 | bonding |
| 56 | handling tool |
| 58 | base plate |
| 60 | folding tool |
| 62 | stripping tool |
| 64 | lower longitudinal edge (stripping tool) |
| 66 | flank (stripping tool) |
| 68 | feed direction |
| 70 | folding punch, blade-like folding punch |
| 72 | adjusting lever |
| 74 | stroke direction |
| 76 | pivot bracket |
| 78 | pivot axis |
| 80 | pivot movement |
| 82 | detection device, optical detection device |
| 84 | output signal, electrical output signal |
| 86 | evaluation circuit, evaluation unit |
| 88 | error signal |
| 90 | system control |
| 92 | pivoting lever |
| 94 | deflection |
| 96 | separating section |
| 98 | separating joint |
| α | opening angle (of the reshaped folding region) |
| A | distance, horizontal distance |
| B | width, bundle width |
| C | distance, vertical distance |
| TR | transport direction |

1. A method for detecting deviations of a current status from a target status of a packaging unit (10) formed by at least two articles (12) joined together by means of strapping or a packaging blank (14), after production, comprising:
measuring the width of an intermediate space (A) between two directly adjacent articles (12) within the packaging unit (10) or by measuring a distance (B) between the shell surfaces (26) of the adjacent articles (12) of the packaging unit (10) in their most widely spaced-apart positions,
wherein a measured width of the intermediate space (A) or a measured distance (B) represents a current status of the packaging unit (10), and comparing the intermediate space (A) or the distance (B) with a defined target status or with a variably definable target status.

2. The method of claim 1, wherein a faultless packaging unit (10) is detected if a deviation of the current status from a target status falls below a defined maximum value.

3. The method of claim 1, where the target status is a value of zero or approximately zero between adjacent articles (12) from one another or by a defined minimum distance (A) of the articles (12) from one another in the packaging unit (10).

4. The method of claim 3, wherein the measuring step comprises optically detecting the width of the intermediate space (A) or the distance (B).

5. The method of claim 3, wherein the measuring step comprises detecting the width of the intermediate space (A) or the distance (B) by ultrasound or by mechanically operated transducers.

6. The method of claim 4, further comprising adjusting packaging parameters during the production of the packaging units (10) based on the measured width of the intermediate space (A) or the measured distance (B).

7. A measuring assembly, which is a component of a packaging machine for producing packaging units (10) formed by at least two articles (12) combined by means of strapping or a packaging blank (14), which packaging units (10) are conveyed past the measuring assembly or are brought into a measurement region of the measuring assembly,
comprising devices for measuring a width of the intermediate space (A) between two directly adjacent articles (12) within the packaging unit (10) or for measuring a distance (B) between shell surfaces (26) of the adjacent articles (12) in their most widely spaced-apart positions,
wherein a measured width of the intermediate space (A) or a measured distance (B) represents a current status of the packaging unit (10) is capable of being compared with a defined target status or with a variably definable target status,
and wherein the measuring assembly is capable of generating output signals (84) from the measured values and delivering such output signals to a downstream evaluation unit (86) which is operatively connected to the packaging machine.

8. The measuring assembly of claim 7, wherein the evaluation unit (86) is a component of a control device (90) of the packaging machine.

9. The measuring assembly of claim 8, wherein the measuring devices are capable of detecting the width of the intermediate space (A) or the distance (B) between the shell surfaces (26) of the adjacent articles (12) at their most widely spaced-apart positions optically.

10. (canceled)

11. A packaging machine for producing packaging units (10) formed by at least two articles (12) combined by strapping or a packaging blank (14), comprising: a measuring assembly in the region of a transport section for the at least partially finished packaging units (10),
wherein the measuring assembly comprises devices for measuring a width of the intermediate space (A) between two directly adjacent articles (12) within the packaging unit (10) or by measuring a distance (B) between the shell surfaces (26) of the adjacent articles (12) in their most widely spaced-apart positions,
wherein a measured width of the intermediate space (A) or a measured distance (B) represents a current status of the corresponding packaging unit (10), which is compared with a defined or with a variably definable target status,
and wherein the measuring assembly is capable of generating output signals (84) from the measured values and delivering such output signals to a downstream evaluation unit (86).

12. The packaging machine according to claim 11, wherein the evaluation unit (86) downstream of the measuring assembly is a component of or is operatively connected to a control device (90).

13. The method of claim 4, wherein the measuring step comprises optically detecting the width of the intermediate space (A) or the distance (B) with at least one camera; and the method further comprising downstream evaluating of camera signals generated by the at least one camera.

14. The method of claim 5, further comprising adjusting packaging parameters during the production of the packaging units (10) based on the measured width of the intermediate space (A) or the measured distance (B).

15. The measuring assembly of claim 9, wherein the measuring devices comprise at least one detection camera with downstream image evaluation of camera signals generated by the at least one detection camera.
